(19) United States
(12) Patent Application Publication
(10) Pub. No.: US 2007/0156446 A1
(43) Pub. Date: Jul. 5, 2007

(54) Internet-based marketing, productivity enhancement and referral system

(76) Inventors: Timothy S. Jolly, Scottsdale, AZ (US); Wendy H. Netzky-Jolly, Scottsdale, AZ (US)

Correspondence Address: Tim Jolly;Wendy Netzky - Jolly, 7147 E. Rancho Vista Dr. # 2005, Scottsdale, AZ, 85251, US

(21) Appl. No.: 11/643,097

(22) Filed: Dec. 21, 2006

Related U.S. Application Data
(60) Provisional application No. 60/757,069, filed on Jan. 5, 2006.

(51) Int. Cl. G06Q 99/00

(52) U.S. Cl. 705/1

(57) ABSTRACT

A method where sellers advertising on an Internet website pay a fee to a party that refers a customer to the seller for the seller's product or service. Buyers are also able to access helpful tools within the website that allows buyers to view specific pricing and feedback information on a company, product or service.

### FIELD OF THE INVENTION

This invention relates to a method of doing business and advertising on a computer network. More specifically, this is a uniquely designed website where merchants and individuals advertising on the website agree to pay a reward or finder's fee to any party(s) that refers to them a buying client of their item, product or service. Consumers are also able to access helpful tools within the website that allows them to view specific pricing and feedback information on a company, product or service.

### BACKGROUND OF THE INVENTION

Traditionally, businesses and individuals that offer products or services for sale will usually advertise in some form or another in order to reach their buying audience. The most common advertising mediums are generally television, yellow pages, internet, radio, newspaper, printed publications, telemarketing, mailing campaigns, etc. These mediums can be extremely expensive to advertise with especially for businesses and individuals without large and sometimes substantial advertising budgets. Companies trying to reach international markets have an even larger task in front of them since many of these mediums are not viable options to reach other countries. So for many businesses, the cost per lead or the price to generate a qualified prospect can be quite significant. Especially since this type of marketing also tends to produce a lot of “window shoppers” instead of serious “ready to buy right now” type of leads. As a matter of fact, for many businesses it may take numerous or even hundreds of leads to be developed before an actual buyer is found for their product or service. Another problem facing companies today is it's becoming even more difficult to effectively reach their specific markets due to SPAM blocking on the internet, “No Call” lists in the telemarketing industry, and people just generally tuning or checking out when a commercial hits on radio or television. This happens more and more often since most consumers are bombarded with an endless number of advertisements each day. In order to combat this problem, many companies utilize referral programs in order to encourage and reward individuals, especially past buyers, to refer their acquaintances to the business. These “word of mouth” leads are excellent, and undoubtedly the best quality lead, but the actual amount of referral leads produced by an internal referral program typically only accounts for a very small portion of a business's revenue. So to date, the major problem still facing businesses of all sizes is:
1. There is still not a reliable cost effective advertising medium for businesses to globally market their products or services through that also produce consistent high quality leads which specifically reach a business's targeted consumer.
2. There is also no common place where you can access all businesses in one place, such as the internet, that offers a finder's fee or reward to any party (referrer) that refers to them a buying client (buyer) of their product or service, according to a seller's prerequisites.

In addressing the reverse end of the spectrum we also have the customers of these businesses whose needs are also not being met. As an example, consumers worldwide are constantly trying to shop around first before they commit to buying something. This is done generally because:
1. The consumer wants to make sure they get the best deal or price on the product or service they are trying to purchase and,
2. They want to make sure the product or service they are purchasing is a good product and has a good or reliable reputation. This in many cases also involves not just the product's reputation but both the company's and their service habits as well.

Conventionally, most patrons nowadays accomplish this by first asking acquaintances or by calling a city's Better Business Bureau. The problem with these two methods is that most acquaintances don't have a lot of first hand or objective information about many of the company's products or services but may have just heard something through “word of mouth”. On the other hand, a city's Better Business Bureau may have information on numerous companies but this technique is only complaint driven and doesn't give you any of the positive feedback. In addition, the bureau's information deals more with the business's character and compliance with the law instead of an actual product's reliability or history. In other words, the bureaus don't offer a good and bad rating system for the company and the product and/or service they offer. At the present time however, more websites are now offering feedback sections which do list past consumer's positive and negative feedback on companies, products and services. This method is extremely effective in delivering exactly what consumers need to know before making a purchase but unfortunately this still has limitations. This is because all of the existing websites with feedback capability are only set up to give feedback when the item purchased was bought or sold through their website or online somewhere else. This means thousands of companies, products and services worldwide never get to participate in such a valuable feedback system since their product or service isn't sold directly through the internet. This means millions of internet users are still very limited in the types and number of products, services and companies they are able to review before they can actually make a purchase.

In addressing the consumer's cost concerns, clients have numerous options at their disposal to ensure they purchase something at a fair market price. Shoppers typically use such things as the telephone, internet, shopping catalogs, newspaper advertisements, acquaintances, etc. to educate themselves on a product or service's going rate. Most of these areas don't, however, provide the valuable feedback that has been spoken about previously. So to date, there is still not a global based place or website that:
1. Lists the selling price of virtually any product or service whether it can be purchased through the internet or not, and
2. Provide customer feedback on the product, service and/or business's reputation at the same time.

### OBJECTS AND ADVANTAGES OF THE INVENTION

Accordingly, there are several objects and advantages to this invention. One of these objects is to develop highly qualified sales leads for businesses on a global scale. It is also the inventions intention to provide a very affordable advertising medium for all size businesses and types while still providing advertising exposure to a worldwide marketplace. This advantage is apparent since the site provides a broad based geographic source of products and services.

One of the most distinctive objects that this invention provides is that a business pays a finder's fee or reward to any party (referrer) that refers to them a buying client (buyer) of their product or service, according to a seller's prerequisites. So this has an immediate advantage for users of the website since they can potentially receive significant amounts of money by obtaining rewards and finder's fees through the website. It has also been found that it is an advantage to provide all these useful features through the internet. By providing a reward program through a website such as this, a business is able to attract buyers to their business without the marketing guess work. Therefore, this website is also able to deliver the highest quality lead possible for most businesses since these leads are being referred by an acquaintance or by “word of mouth”. These leads, as mentioned earlier, are much more serious as they are “ready to buy right now” type of leads. Through this system, these lead types are also delivered at a much more cost effective basis than most other types of traditional advertising mediums.

Another object of this invention is to give incentives to users to contribute and increase the scope of products and services offered through the system. This would generally be accomplished by offering a reward or finder's fee to any party(s) that refers to the website a new buying client (advertiser), according to the website's prerequisites. This is a major advantage for the website since this greatly increases the income and revenue growth of the site. It also has a major benefit for its consumers since this increases the number of companies, products and services they can choose from when users refer friends or utilize the pricing and feedback comparison features.

Another advantage this invention offers is that it can produce large amounts of high quality leads without being impacted by many of today's laws and technologies that make the average consumer harder to reach. As mentioned prior, SPAM blocking, “No Call” lists, etc . . . make it more difficult to reach consumer households and to speak to someone. Yet, since this website is referral based, a business is always going to receive the potential buyer's contact information directly from a referring party (their acquaintance). This allows high quality leads to be delivered “right to a business's front door”. It also makes for a much easier and unobtrusive way for the business to start the sales process with a consumer. In addition, because this website is also able to literally reach a worldwide market, the potential for developing more referral or “word of mouth” leads, versus many company's “in-house” referral programs, is far greater than any other system available today.

Another object of this invention is to provide a feedback section on all businesses and parties involved with the referral process, as well as the seller's product or service they offer. This feature is an advantage for a referrer and buyer early on in the business search process since they are able to read the valuable feedback on the seller, and the products and services they offer, and make a more informed buying decision before any business transaction takes place. Another benefit of this invention is it will also be able to list significantly more companies, products and services, along with the feedback about these companies, products and services; more so than any other website or advertising medium developed before. As cited earlier, most consumers want to make sure they are getting a fair price for something before it is purchased. They also want to ensure that the company, product or service that they are considering buying also has a good or reliable reputation. Unlike most advertising mediums, this website is able to provide both these features. As an example, one advantage of this invention over telephone books with business entries is that it is less expensive and it provides a repository for feedback related to their products or services. Even though some websites currently do offer pricing and feedback, the range of products and services offered on these sites are restricted. This again limits millions of internet users on the number of products, services and companies they are able to review before they can actually make a purchase decision. This is because thousands of products and services are bought and sold globally every day but not through the internet. This innovative website is able to accommodate virtually any worldwide business, product or service with its unique pricing and feedback comparison features. It can be achieved because this website invention is an advertising medium and a referral network which doesn't require the internet user to necessarily purchase the product or service online. As an example, if a plumbing service advertised on this unique website, the plumber's customers could give feedback on the website regarding his work although the monetary or business transaction never took place online. The same could also be said for countless numbers of local and international businesses as well.

An added benefit of having a site of this magnitude with feedback is people worldwide will also visit the site just to use it for its feedback feature. In other words, even if a person didn't have a friend or acquaintance to refer or that referred them, any individual could utilize this feature in the site. This would hold true whether the user was registered with the site or not because they can still gain access to a business's reputation and feedback well before they purchase a product or service themselves. So in turn this feature has a side benefit of acting like a global business listings telephone book with feedback. This will be particularly helpful to countless numbers of people across the world since so many products and services can not be directly purchased through the internet. This would then potentially result in thousands of visitors frequently visiting the site, who aren't necessarily interested in referring somebody right now, but will expose them to all the positive attributes of the website and encourage future referrals.

So in recap this invention will be able to provide consumers with a way to view pricing and feedback information on more companies, products or services than ever developed before. It will also allow more businesses or individuals worldwide to have a cost effective advertising medium that reaches global markets and is able to deliver high quality and “ready to buy” sales leads to businesses. Additionally, the concept of offering rewards or finder's fees to any party(s) that refers to a business a buying client through this website benefits everybody involved in the transaction. To begin with, the business is pleased because they got a buying customer. Secondly, the customer or buyer is happy because they purchased exactly what they wanted. Lastly, the referring party is ecstatic because they received a reward or finder's fee for referring their friend to the business. In other words it's a “win win” scenario for all parties. So in conclusion, as will be apparent from the following descriptions of the invention, it will be appreciated that a system and method of a global referral, feedback and reward based system of this magnitude will allow the realization of the above objects and advantages of the system.

### SUMMARY OF THE INVENTION

It is in object of this present invention to provide a unique, one of a kind website, that requires merchants and individuals wishing to advertise on the site to agree to pay a reward or finder's fee to any party(s) that refers to them a buying client of their unique item, product or service. This site will also be structured in such a manner that consumers will be able to access numerous pages and helpful tools that allow the user to view specific pricing and feedback information from a list of diverse companies, products, requests and services.

The preferred embodiments of the invention presented here are described below in the specification and shown in the drawing figures. Unless specifically noted, it is intended that the words and phrases in the specification and the claims be given the ordinary and accustomed meaning to those of ordinary skill in the applicable arts. If any other special meaning is intended for any word or phrase, the specification will clearly state and define the special meaning. In particular, most words have a generic meaning. If it is intended to limit or otherwise narrow the generic meaning, specific descriptive adjectives will be used to do so. Absent the use of special adjectives, it is intended that the terms in this specification and claims be given their broadest possible, generic meaning.

Likewise, the use of the words “function,” “means,” or “step” in the specification or claims is not intended to indicate a desire to invoke the special provisions of 35 U.S.C. 112, Paragraph 6, to define the invention. To the contrary, if the provisions of 35 U.S.C. 112, Paragraph 6 are sought to be invoked to define the inventions, the claims will specifically recite the phrases “means for” or “step for” and a function, without also reciting in such phrases any structure, material or act in support of the function. Even when the claims recite a “means for” or “step for” performing a function, if they also recite any structure, material or acts in support of that means or step, then the intention is not to invoke the provisions of 35 U.S.C. 112, Paragraph 6. Moreover, even if the provisions of 35 U.S.C. 112, Paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, material or acts for performing the claimed function.

### BRIEF DESCRIPTION OF THE FIGURES

FIG. 1A is a flowchart detailing page 1 of 3 for the homepage of the website. This page shows the various options that a user has to choose from when entering the homepage and the resulting paths or pages that result from each selection.

FIG. 1B is a flowchart detailing page 2 of 3 for the homepage of the website. This page is a subsidiary of FIG. 1A. Both FIGS. 1A and 1B are joined together at point A. This page shows the various options that a user has to choose from when entering the homepage and the resulting paths or pages that result from each selection.

FIG. 1C is a flowchart detailing page 2 of 3 for the homepage of the website. This page is a subsidiary of FIG. 1A. Both FIGS. 1A and 1C are joined together at point B. This page shows the various options that a user has to choose from when entering the homepage and the resulting paths or pages that result from each selection.

Exhibit A1 is a flowchart showing the activity necessary to interface a typical user using the login system. The process will begin by querying the user for their user name and password and ending with directing the user to the appropriate website section.

Exhibit A1.1 is a flowchart showing the activity necessary to interface a typical user using the account balance and payment history system. The process will begin by querying the user if they're logged in and ending with the account balance and payment history results.

Exhibit A1.2 is a flowchart showing the activity necessary to interface a typical user using the current and prior account activity system. The process will begin by querying the user if they're logged in and ending with the current and prior account activity results.

Exhibit A1.3 is a flowchart showing the activity necessary to interface a typical user using the business or personal information system. The process will begin by querying the user if they're logged in and ending with displaying the requested information results.

Exhibit B1 is a flowchart showing the activity necessary to interface a typical user using the business feedback system. The process will begin by querying the user if they want feedback on a product, service, business or seller and ending with the search and retrieval feedback results.

Exhibit C1 is a flowchart showing the activity necessary to interface a typical user using the previous picks system. The process will begin by querying the user if they're logged in and ending with displaying the user's requested retrieval results.

Exhibit D1 is a flowchart showing the activity necessary to interface a typical user using the refer someone to a business system. The process will begin by querying the user if they're registered and ending with forwarding the referral's contact information to the vendor(s) that it was selected to go to.

Exhibit E1 is a flowchart showing the activity necessary to interface a typical user using the Payment System. The process will begin by querying the user if they want to register or update information and ending with completing the task that the user requested.

Exhibit G1 is a flowchart showing the activity necessary to interface a typical user using the “Advertise with Us” system. The process will begin by querying the user if they're registered and ending with the user completing the online registration process.

Exhibit I1 is a flowchart showing the activity necessary to interface a typical user using the business, product or service search system. The process will begin by querying the user if they're registered and end with the user's search and retrieval results.

Exhibit J1 is a flowchart showing the activity necessary to interface a typical user using the business, product or service advanced search system. The process will begin by querying the user if they're registered and end with the user's search and retrieval results.

Exhibit L1 is a flowchart showing the activity necessary to interface a typical user using the “Help Me Find the Goods” system. The process will begin by querying the user if they're registered and ending with the user's search and retrieval results.

Exhibit M1 is a flowchart showing the activity necessary to interface a typical user using the “Help Wanted” system. The process will begin by querying the user if they're registered and ending with the user's search and retrieval results.

Exhibit N1 is a flowchart showing the activity necessary to interface a typical user using the “Wanted Citizens” system. The process will begin by querying the user if they're registered and ending with the user's search and retrieval results.

Exhibit O1 is a flowchart showing the activity necessary to interface a typical user using the “Lost and Found” system. The process will begin by querying the user if they're registered and ending with the user's search and retrieval results.

Exhibit R1 is a flowchart showing the activity necessary to interface a typical user using the miscellaneous referral system. The process will begin by querying the user if they're registered and ending with forwarding the users/referrals contact information and selection choice to the vendor/party that it was selected to go to.

### DETAILED DESCRIPTION OF THE INVENTION

The invention is a global referral, feedback and reward based website that brings buyers, both individuals and businesses, wishing to purchase virtually any product or service, together with the sellers of these products or services through the medium of the internet in any country. This website is particularly unique because it is an international advertising website designed for businesses or individuals to promote their products or services on by offering a reward or finder's fee. As an example, a seller (being a person, group or business) would pay a finder's fee or reward to any party (referrer) that refers to them a buying client (buyer) of their product or service, according to that seller's prerequisites.

Rewards, Credits and Rebates—Once a referrer has met the seller's prerequisites for receiving a reward, the incentive may be in the form of money (check), credit on their personal or business credit card, gift certificate, credit towards a future purchase of the seller's product or service, gift card or any reward approved by the website. A seller may also allow the referrer to choose between various reward options but the seller should always offer the cash option or equivalent as a choice. Equivalent meaning any form of reimbursement that acts the same as cash where the referrer is not just limited to choosing a credit towards the purchase of the seller's product or service. As an example, a referrer would have the option to choose between: 1. A $50.00 cash reward (check) or credit on their personal or business credit card or 2. A $75.00 credit towards a future purchase of that seller's product or service. This method works best for most reward beneficiaries especially since they may not have any personal interest in purchasing a seller's products or services with a credit at this time. Generally speaking however, the seller of the products or services will determine the amount of the reward, what the reward is, the expected time frame in which the referrer can expect to receive the reward and whom is eligible to receive the reward as long as its in compliance with the website's rules and regulations. In other words, the seller may wish to reward the referrer and the buyer both in some capacity for purchasing their product(s) or service(s). A minimum reward or referral fee amount may also be instituted by the website in order to not needlessly clutter a certain site's category with minuscule reward amounts or incentives.

Another component of this section, as well as others, is to allow and encourage multiple referrals by referring parties through building in a tier system. This arrangement would offer greater incentives for a referrer to pass on more than one potential buyer to the same seller over and over again. (E.g. $100.00 for the first referral, $150.00 for the second and $200.00 for the third).

A further embodiment of the website would also permit sellers to utilize and advertised rebates within the website. This rebate option would primarily be used in, but not limited to, the following circumstances: 1. Rewarding a party (buyer) for continued customer loyalty, 2. Providing an incentive to help sell a business's specific product or service such as overstocked or discontinued items, 3. Providing an enticement for any purchases made online or 4. As a general means to create repeat business. Under these scenarios as well as others, it would be possible for an individual to receive a rebate without being referred by somebody else. As long as the vendor is in compliance with the site's rules and regulations, the seller once again would determine the prerequisites for receiving the rebate, the amount of the rebate, what form of compensation the rebate will come in, the expected time frame in which the party can expect to receive the rebate, and who is eligible to receive the rebate.

All accounts, methods and descriptions described in this Rewards, Credits and Rebates segment are applicable to all applicable sections contained within the website.

Donation Option—Another important component to this site is to allow people the option of giving and donating their rewards to others. This would be accomplished by permitting the finder's fee recipient to give all or a portion of their finder's fee or reward money to another party directly through the website. (E.g. Non profit organization, the referred buyer, relative, friend, business, schools, charity, etc.)

Last Minute Referrals—Frequently people at the last minute may want to take advantage of the website's referral and reward program but find themselves not near a computer. Under this scenario, as long as the referrer is pre-registered the entire referral process could be completed over a phone using a designated phone number belonging to the website. A customer representative would access and input all the required information into the website for the party thus allowing the seller of the desired products or services to have their required information before the buying party arrives. If this same scenario existed but the referrer was not pre-registered with the site yet, then the referrer could either pre-register at the place of business where they are referring their acquaintance or they could pre-register at the closest approved registration site. Please note that registration would only be able to take place at a seller's place of business only if they have an available computer to use with online access to the website. If the seller was not equipped for this option then the referrer would contact the same customer service department by phone as described above and they would direct the party to the closest approved registration site. Approved registration sites would typically be pre-approved seller sites that are already registered with the website. Another type of registration site would be kiosks, booths, information desks, etc . . . at or near popular retail locations. This would typically include but are not limited to places such as auto malls, shopping centers, indoor and outdoor shopping malls, high public traffic areas near retail businesses, etc.

Previous Referrals, Buyers or Customers—Due to the high volume of leads that many businesses will receive when participating in the referral and reward program, a special option will exist in the site that helps prevent and screen duplicate referral leads. In other words, a party that was already referred prior or as an existing past customer of that business. So this process is particularly helpful for sellers that don't permit reward or finder's fees to be paid out on existing customers or parties that have already been paid a reward in the past by them. This screening though would only take place by the website at the seller's request. This type of screening process would also not be activated until the seller's established customer records were successfully downloaded into the website's databases and servers established solely for this purpose. For security and good will purposes, the website promises to the seller to never use this stored electronic information for anything other than helping to prevent duplicate referrals from occurring. Once that seller's client information has been accurately loaded, a referrer would automatically get a “duplicate warning message” anytime a particular business has that same buyer's information already in their records. Definitions of a duplicate lead would also be pre-defined by the business that is screening them. In other words, the business's previous records could be electronically scrubbed for names, addresses, phone numbers and date ranges, to help prevent a possible duplicate record from being entered. This screening would also still work even if a person utilized the website's designated phone number as described above.

Referrer and Seller Agreements—In order to help safeguard the buyer's personal information from being misused or given out without proper consent, the seller would agree to certain terms during the seller's original registration process with the website. Accordingly, the seller would agree to abide by the following: The seller agrees to contact the potential buyer for the exclusive purpose of trying to solidify this one potential sales transaction only. Any and all future correspondence with the buying party is strictly prohibited without the buyer's prior consent. The seller also further agrees not to solicit to and cease all forms of communication with the possible buyer at any point that the party requests to do so. In addition, the seller agrees not to sell, give or publish any portion of the potential buyers name or contact information to another party or vendor. Subsequently, the referrer must also agree to certain terms during the referrer's original registration process with the website. Therefore, the referrer would agree to abide by the following: The referrer agrees not to sell, give or publish any portion of a potential buyer's name or contact information to any party or vendor without the buyer's prior consent. Any buyer's information being given out will solely be for the purpose of trying to help the two outside parties to come together to solidify an independent product or service transaction. Each referral being given out will require a separate consent from the buyer even if the buyer gave prior consent to a prior referral transaction. This policy will be strictly enforced by the site unless the buyer gives the referrer permission in writing to give out their name and contact information to any party regardless of time constraints and without limitation. This permission can also be achieved by the buyer listing their name as a limitless referrer in the buyer's personal registration section of the website. The buyer also reserves the right to change their mind at anytime. The other purpose that the seller and referrer's agreements serve, besides protecting the proper parties, is it maintains the integrity of the website and also helps to filter a better quality lead to the sellers instead of just random names being sent out each day to every seller in the site.

Revenues and Fees—Revenues for the website would be generated by having the seller, or responsible party, pay a fee for advertising and listing their reward fee, as well as the products or services they provide. Fee amounts and schedules for the sellers may be determined by the length of time they wish to advertise (e.g. by weeks, month or year), by the size of the advertisement, and/or the categories that the listing is under. Revenues may also be produced by using various charging methods such as cost per click, per impression or per referral. Another revenue option is to charge a percentage for every finder's fee or reward money being paid out. Additional monies could also be gathered by charging a fee to businesses or individuals wishing to post additional pop up ads throughout the website or wishing to have their own website's link available on their advertisement or listing page. This charge would be justified since this would direct the user away from the website and on to the seller's website. Another nominal fee could also be charged if the seller needs or wants significant help from the website's employees in developing a special advertisement and/or webpage versus just a listing. Due to the huge global market potential of this site, a seller may also wish to pay additional monies to give them better exposure or a higher sort order in a particular category or portion of the website. To help keep online money transactions secure and timely, all parties will be strongly encouraged to use the site's preferred electronic method of payment (Payment System).

New to Website—In the “New to Website” section, also listed as Exhibit H1, reflects where the site's electronic audio and video tutorial will take place. This tutorial is designed to expose new visitors and users of the website to the numerous benefits it offers. It is also meant to further educate users on the many advantages this site has and how they can financially profit from it. This tutorial will also allow the user to individually choose and learn more about specific aspects of the site and the simplicity of how it works. Each area covered in the tutorial will feature streaming video, along with audio and an on-screen text option, thus allowing the viewer to see actual demonstrations of how to utilize a portion of the website. This section would also permit the user to use controls when playing the video such as fast forwarding, rewinding, pausing, stopping, playing, sound on or off, etc.

It is expected that an effective audio and video tutorial system will be provided on this website. Many current websites have such a tutorial system for parties accessing the website as a new user. An example of such a system is available on the Ebay.com website. More specifically the “Learning Center” section of the eBay site includes examples of related links, logic, streaming videos, audios and examples.

User Registration—The page known as the “Register with Website” section, currently listed as Exhibit K1, represents an electronic method of registering new users to the website. In order to be an eligible participant in the referral process, the website would be built in such a manner that referrers, and sellers would be required to register online beforehand. The main prerequisites for registration would have all parties complete certain required fields and agree to the terms and regulations of the site in order for the registration to be valid. Typical required information would include their full legal name, name of business, mailing or business address, city, state, zip code, email address, and home, business and/or cell number. After a party has adequately registered, an account or ID number will be assigned to the individual or business. An auto reply will normally be generated to the users email address once the process has been successfully completed.

To make the registration process simpler for those who don't have easy access to the internet, a designated phone number belonging to the website would be utilized to help accommodate these individuals or businesses. Under this circumstance, the service representative will simply input all their pertinent information into the website via the telephone and simply send them an agreement addendum in the mail. This agreement would outline the user's responsibilities to abide by the policies of the website. A signature agreeing to the terms would also be required as well as sending back the signed agreement inside the website's self addressed return envelope. After a party has adequately registered, business reply mail will normally be generated and sent to the users mailing address once the process has been successfully completed. This will typically contain the new account or ID number that was assigned to the newly registered individual or business.

Another benefit to assigning unique account or ID numbers to every new user is it will help to ensure there are no identity mistakes during the referral process. A password will also be required and created by each new user during this initial registration process as well. This way a user can only access their own private information and account activity since a password must be used in order to access any account. This password also acts as the user's login whenever they login to the website. By also having all parties register beforehand, this allows the users information to be easily retrieved and utilized in upcoming transactions without having to manually type their information over again. As an example, a person could refer a number of different people to one of their business favorites repeatedly without having to manually input their own information over again for each referral. In addition, it's important to note that a person, depending on the transaction, may either be a buyer, seller (business) or a referring party. However, since they were already registered, they could simply download all their required information instead of manually typing it in again regardless of the transaction type. This results in simplifying and expediting the referral process for individuals wishing to utilize the site's referral and reward program for years to come.

In order to get an idea of an effective user registration system for any party utilizing the website, the reader is directed to the forms of user registration methods, information collection and storage, security processes, instructions, and art contained on various internet sites such as the eBay.com website. Specifically the “Register: Enter Information” section of the eBay site includes related web pages such as the defined User Agreement and Privacy Policy addendum; such tools are contemplated by the inventor as being tools that would be associated with this sector.

Advertisers Registration—Exhibit G1, also referred to as the “Advertise with Us” section, shows the process that an individual or vendor must follow in order to be a participating vendor or advertiser on the website. In addition, all advertisers must agree to all the terms and agreements of the website before any payment is accepted by the site and any advertisement posted.

Business Search and Referral Process—Once a party wishing to refer someone has registered online, they would start utilizing a series of pages built into the site to help accelerate the referral process. Exhibit D1, also referred to as the “Refer Someone to a Business” section, shows how a user will typically locate a vendor, using a predefined search process. After selecting the appropriate vendor, the diagram shows the process necessary in order to refer an acquaintance to the merchant selected. This outline also shows how the acquaintance's contact information is forwarded to the merchant and that an auto reply is automatically generated back to the referring party.

If a user wants to locate a seller or business that they have previously used, the user could utilize the “Previous Picks” page, as featured in Exhibit C1. This unique page lists any prior businesses or selections that they have chosen to view and save before. This also allows the user to more quickly access frequently used businesses without having to do a formal search each time to find them.

Since this website would also be utilized on a global basis, a language toolbar will also be built into the site to accommodate users of different languages. This distinctive webpage is represented in the “Language Tools Section” of the website, also listed as Exhibit P1. Such language tools systems are known in the industry. For instance the Google™ internet web site includes a language system with language tools, methods, information collection and storage, technology, instructions, and other elements that enhance the website and make it language flexible. Furthermore, the language systems that appear on internet websites may include sort capabilities, drop down options, logic and results listings. The inventor contemplates that language systems as are known in the on line business community may be used in this invention. In this invention the “Language Tools” section includes all related web pages associated with this sector.

Furthermore, if an individual is experiencing problems operating, understanding or navigating through a portion of the site, the user will also be able to utilize the “Help Tools” section also referred to as Exhibit Q1. This section is designed to aid those individuals needing extra assistance. “Help” selections are known in the internet marketing and service arenas. An effective help tools system for this invention may be garnered from similar help tool elements used by internet businesses. Such systems, for instance the “Google Help Center” uses forms of help tool methods, information collection and storage, technology, instructions, and art contained that may be usable in this invention. This site, like many others of similar capabilities may incorporate sort capabilities, drop down options, logic and results listings technologies that would be useful in this invention.

If during the referral process a user is starting their general search for a business, product or service, the methods listed in Exhibit I1 and J1, also known as the “General and Advanced Business, Product or Service Search” sections, shows how a typical user would proceed to find a particular business, product or service.

These illustrations also indicate which search field options would need to be completed in order to result in a more specific and narrowed down result. Examples of seller search and sort features offered within the site would include: 1. Search capability by name of business or website, product or service category, country, state, city and zip code, 2. Sort by proximity (predetermined mile radius) 3. Search capability by product and/or service categories, 4. Search capability by a general or advanced search bar, 5. Sort results by price range, referral fee amount or reward value being offered and 6. Sort capability by feedback score or rating. Other sort variables could also be utilized but these just represent a fraction of the methods that will be used. A map and directions link would also be built into the site for the user's convenience as well.

Once the appropriate seller, website or listing is found, the referrer would then input or download the buyer's contact information into a designated area which contains certain required fields in order for the referral to be valid or sent. Another component would also allow the referrer to send their buyer's contact information to more than one seller at a time during the referral process. A typical buyer's information would include their full name, mailing address, city, state, zip code, email address, and home and/or cell number. The site would also be built in such a manner that the buyer's contact information could be electronically downloaded instead of manually inputted each time. This could be accomplished as long as the buyer was pre-registered beforehand. The electronic download would actually occur once the referrer locates the buyer's contact information in a predetermined shortcut built into the site and simply clicks a download button to update the required fields. Once these required fields are completed, the information will be emailed directly to the seller thus allowing the business to contact the potential buyer about their product or service. If the business or seller was in a remote location without internet access, the website could either call the business with the referral information or mail the information to the business's mailing address. This same required process would also work similarly for all other facets of the website. Additionally if a referrer is trying to refer someone to a seller, but that seller is not yet registered or listed in the website, a phone call, physical mail out or e-mail will be immediately initiated by the website to this potential seller in order to help establish the relationship between the parties.

Again eBay, as well as other web based businesses are well versed in and provide effective search and retrieval systems for any party utilizing the website. Specifically the “Advanced Search” section of the eBay site, and all related web pages, provide an illustrative technique for representative search and retrieval systems.

Feedback—The critique or feedback section is one of the website's most important and valuable features. Exhibit B1, which is known as the “Business Feedback Section”, is the webpage where this feature will be utilized. The general purpose of a feedback system is to aid in making buyers aware of sellers, products or services with poor track records or history with consumers. This system is also designed to benefit users of the “Help Me Find the Goods”, “Help Wanted”, “Wanted Citizens” and “Lost and Found” sections of the site. This can also include businesses or individuals who have not kept up their end of the bargain by paying the referral or reward fee in a timely manner as contracted in the seller's registration agreement, or have misused or violated the buyers name and contact information. On the other hand, the sellers may also get protected from buyers who have shady reputations for making unjustified or fraudulent claims against other company's products or services. There are numerous benefits of having a negative feedback section, this would be just a fraction of the examples.

Conversely, if a seller has positive feedback, this would create a huge incentive for referrers to refer their acquaintances to that business's product or service. This also encourages people to purchase from that same business in the future thus creating a higher standard for other businesses to follow in today's world marketplace. In other words, the end result of positive feedback raises the level of ethics and integrity for all parties involved regardless of whether they are a seller, buyer or referrer. Due to the enormous number of business listings this site potentially will have, internet links and/or phone numbers to Better Business Bureaus and Registrar of Contractors will be available for access. This is created in case a user would like to more thoroughly investigate a potential business. In addition to the valuable assets that feedback offers as mentioned prior, it also helps the site to clean up or possibly eliminate a party or business from the website that is not abiding by the terms of the site's agreement.

The inventors believe that a feedback system is highly desirable in their system. They are aware that the eBay feedback system, as well as other feedback systems as used in many web business systems, is a model of a representative system. These systems, and the system used in the inventors business method presented here, will have appropriate feedback methods, information collection and storage, security features, instructions, and art similar to what is done by eBay and other web based businesses known to the inventors. More specifically the inventors Feedback Forum will use sort capabilities, drop down options, logic and results listings technologies as are know in the industry.

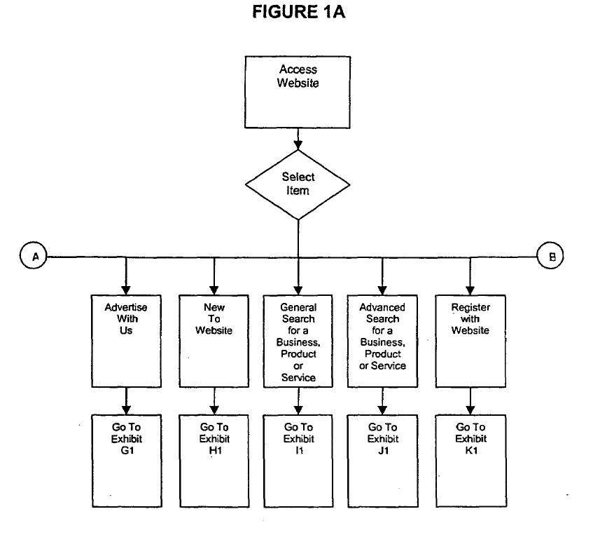

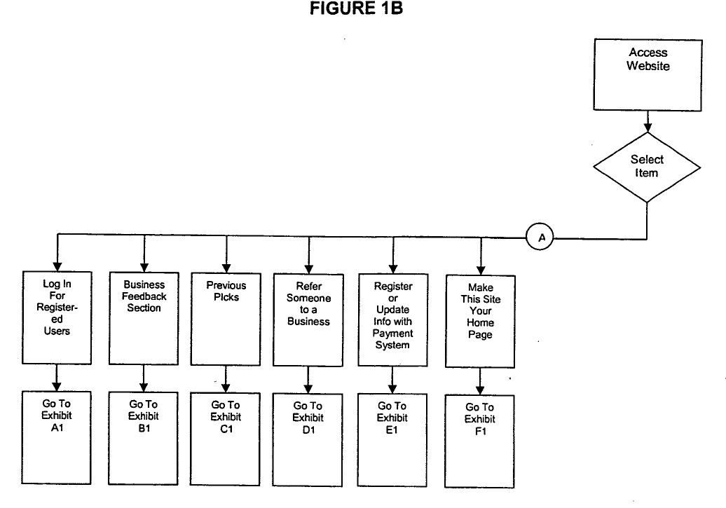

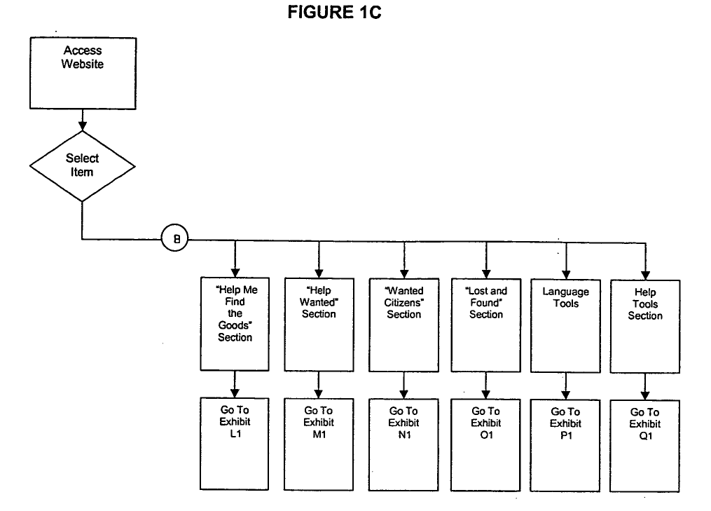

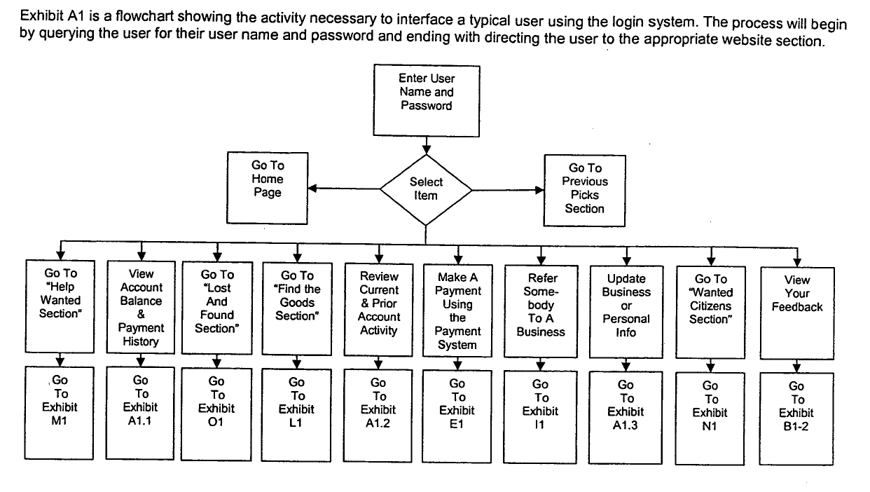

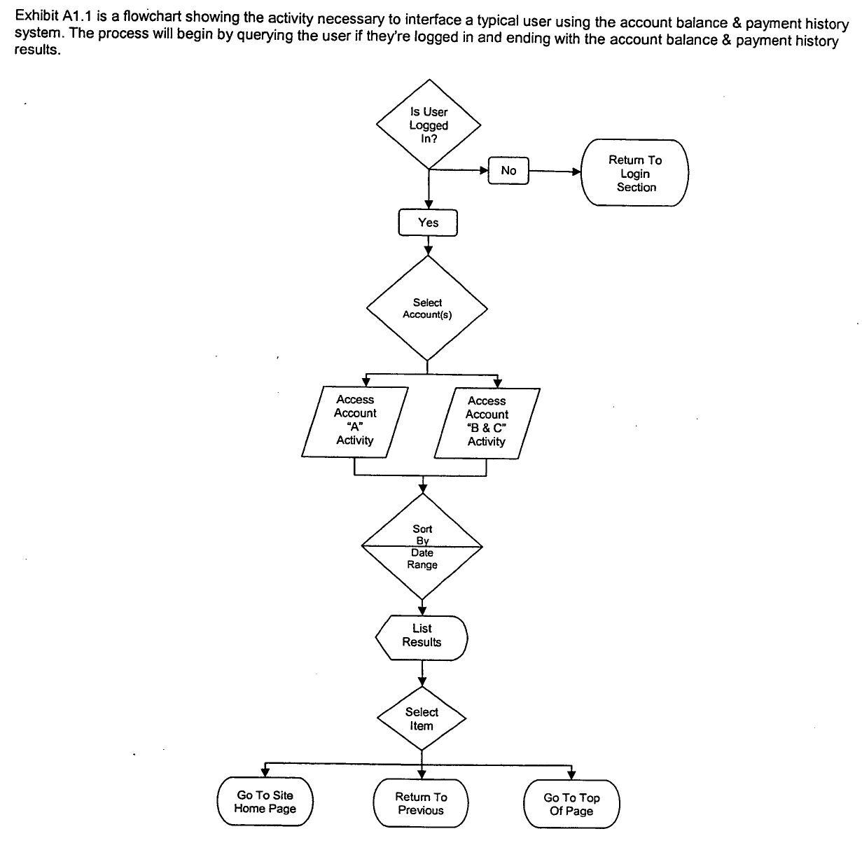

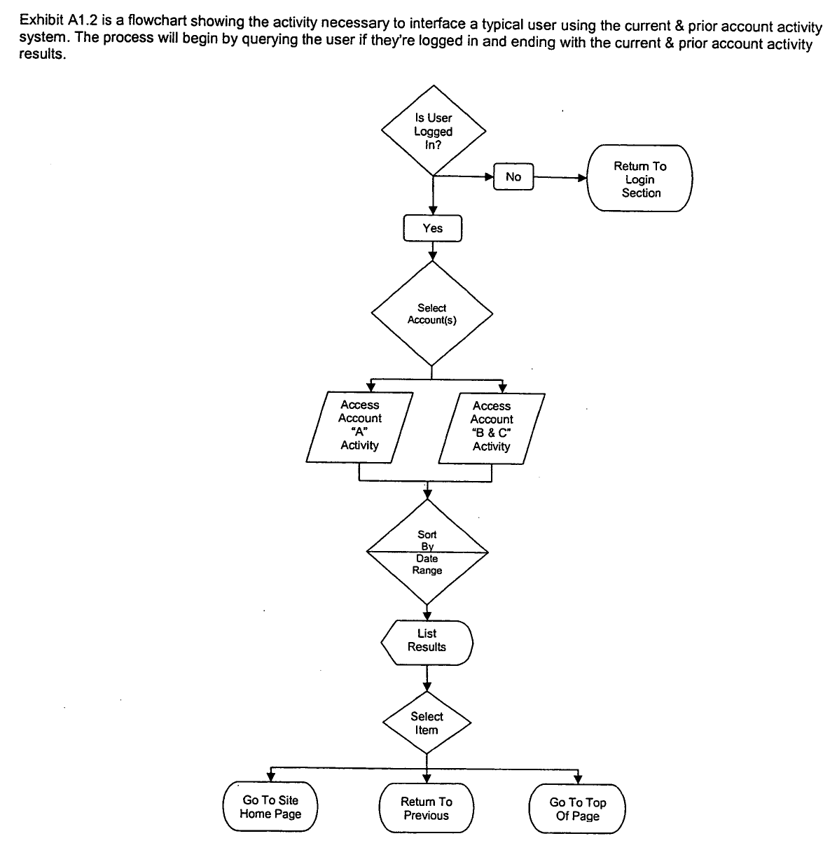

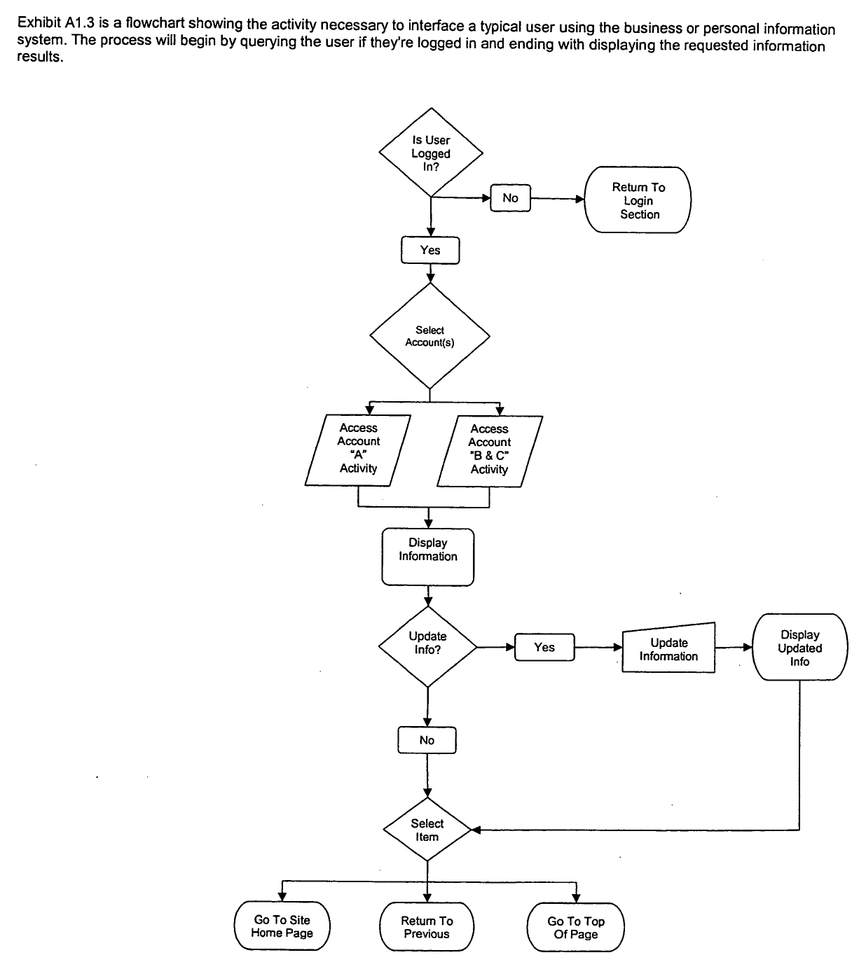

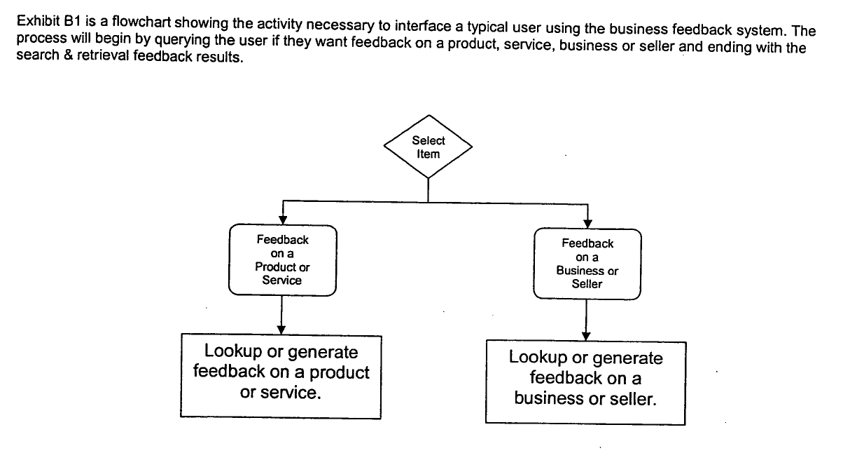

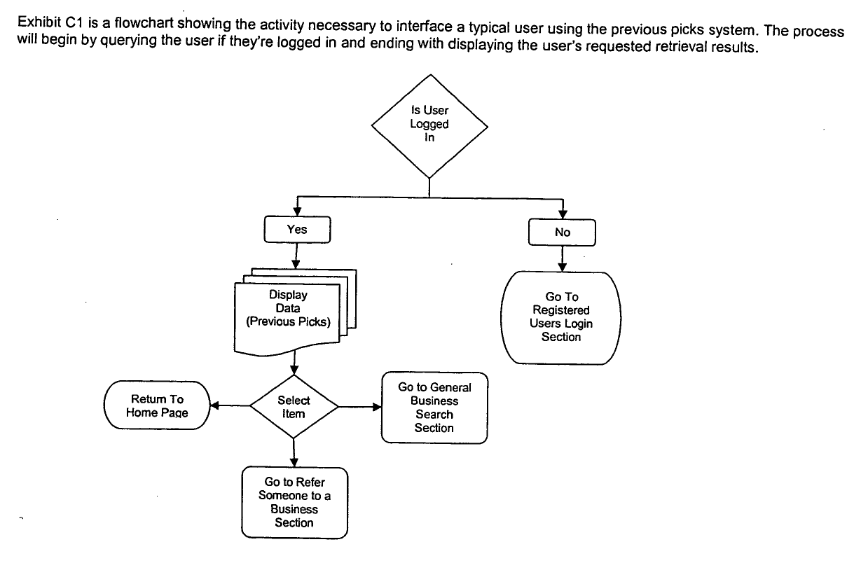

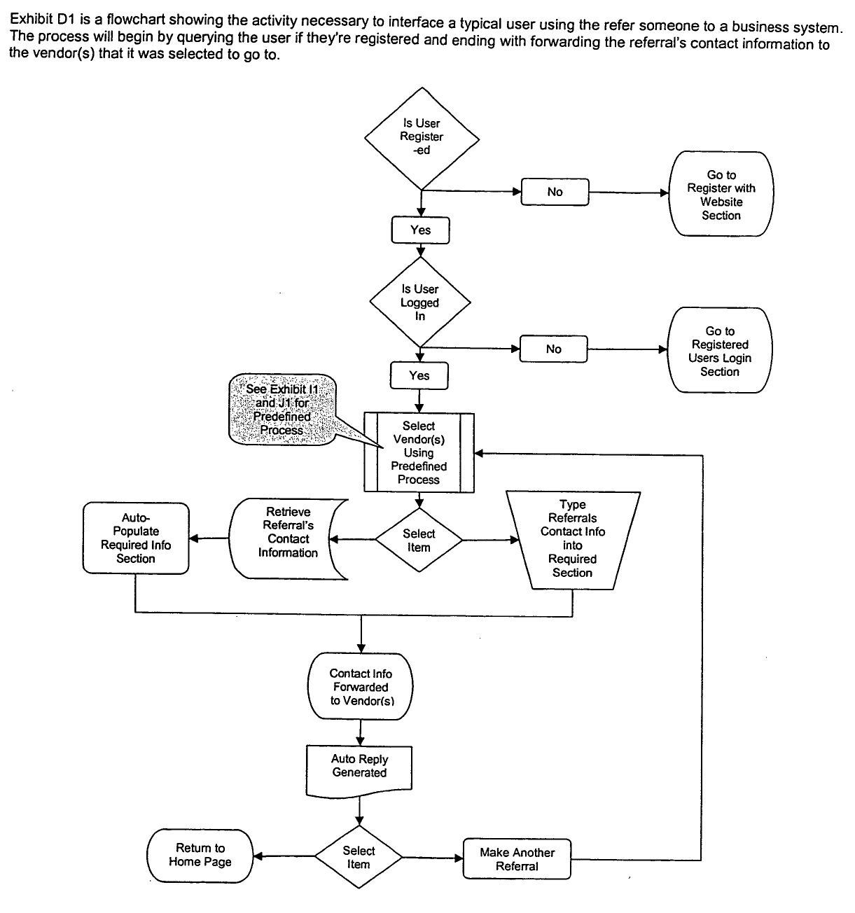

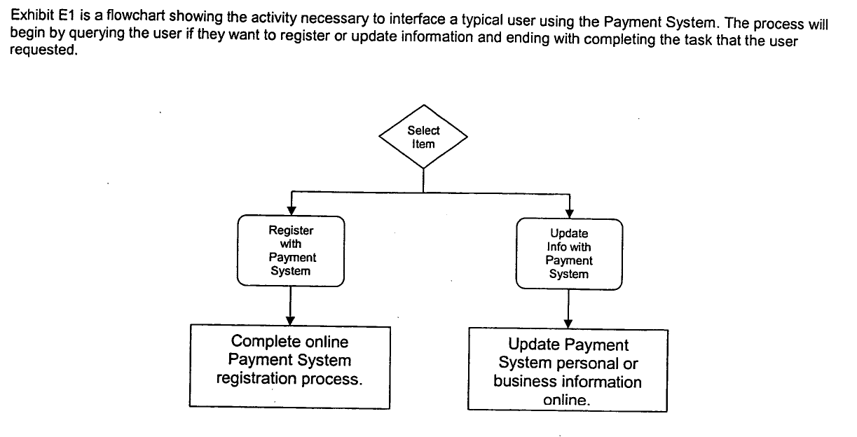

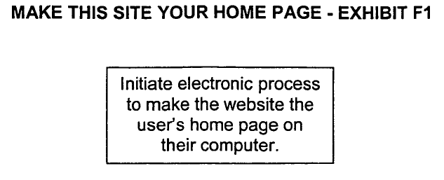

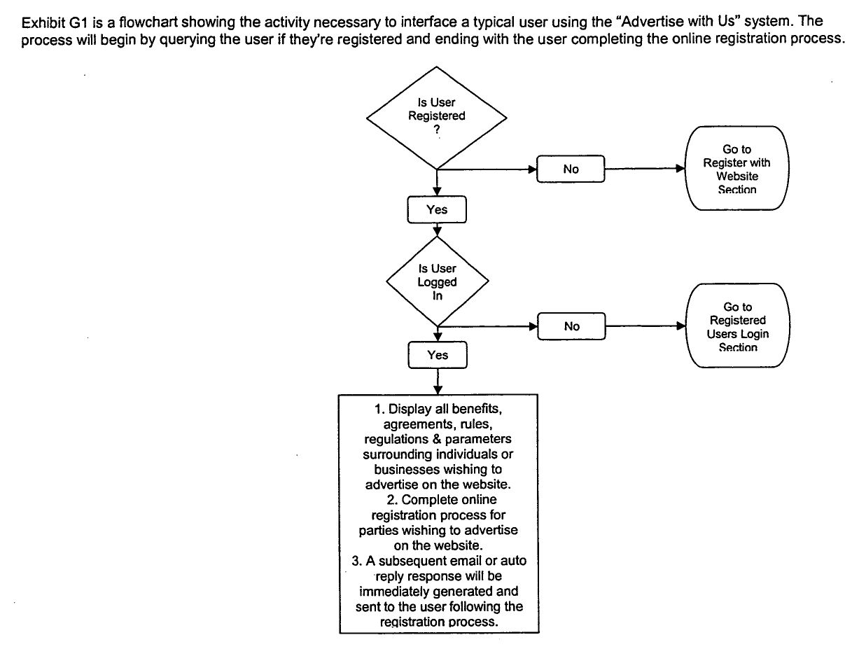

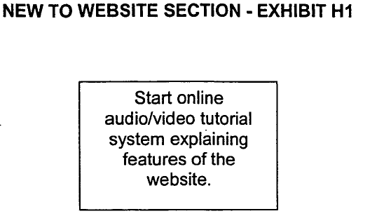

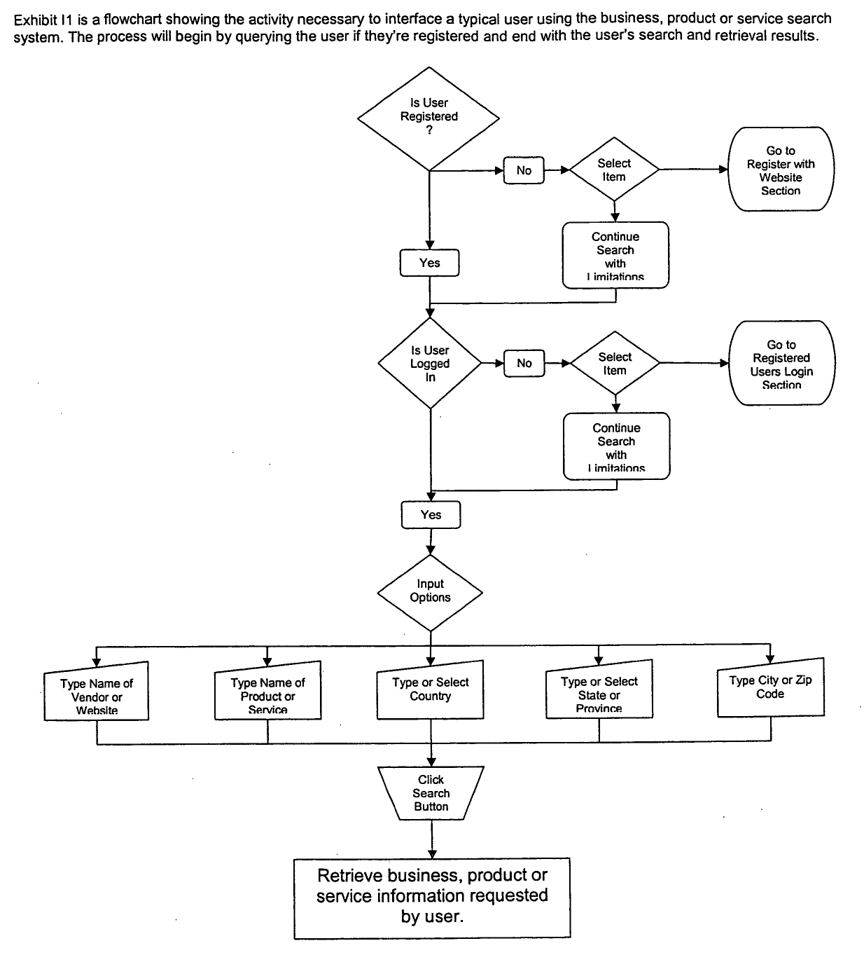

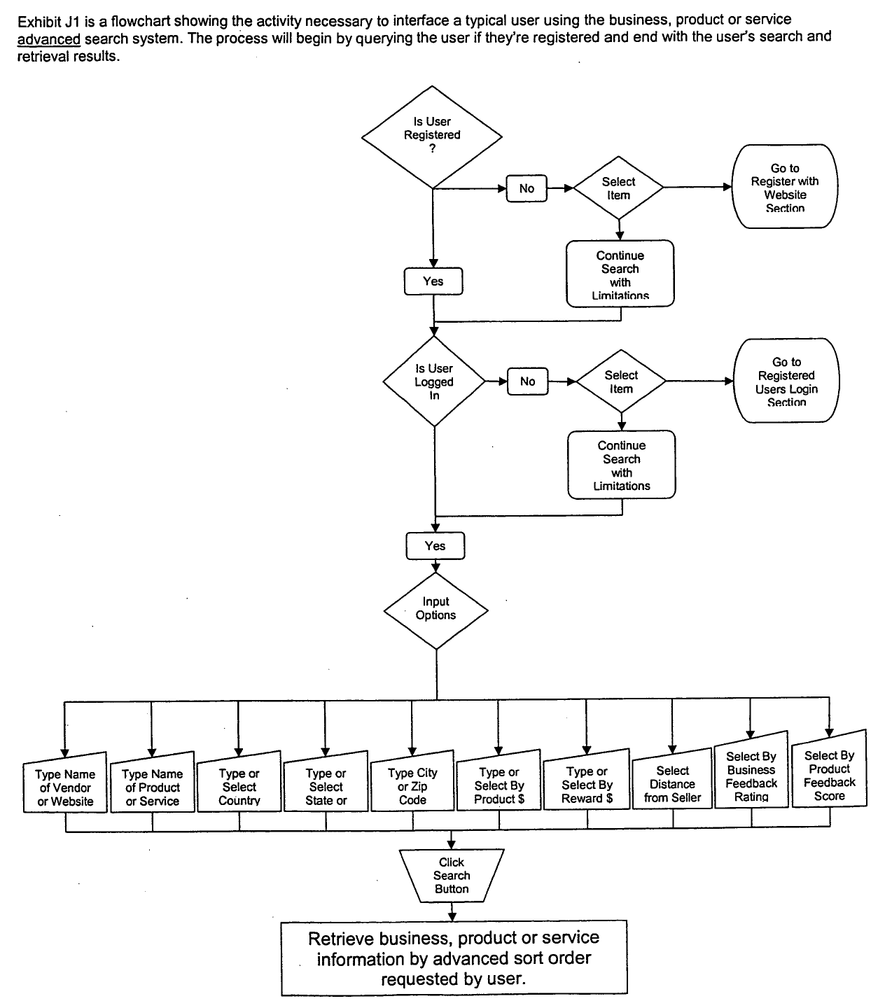

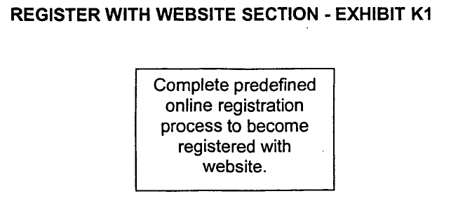

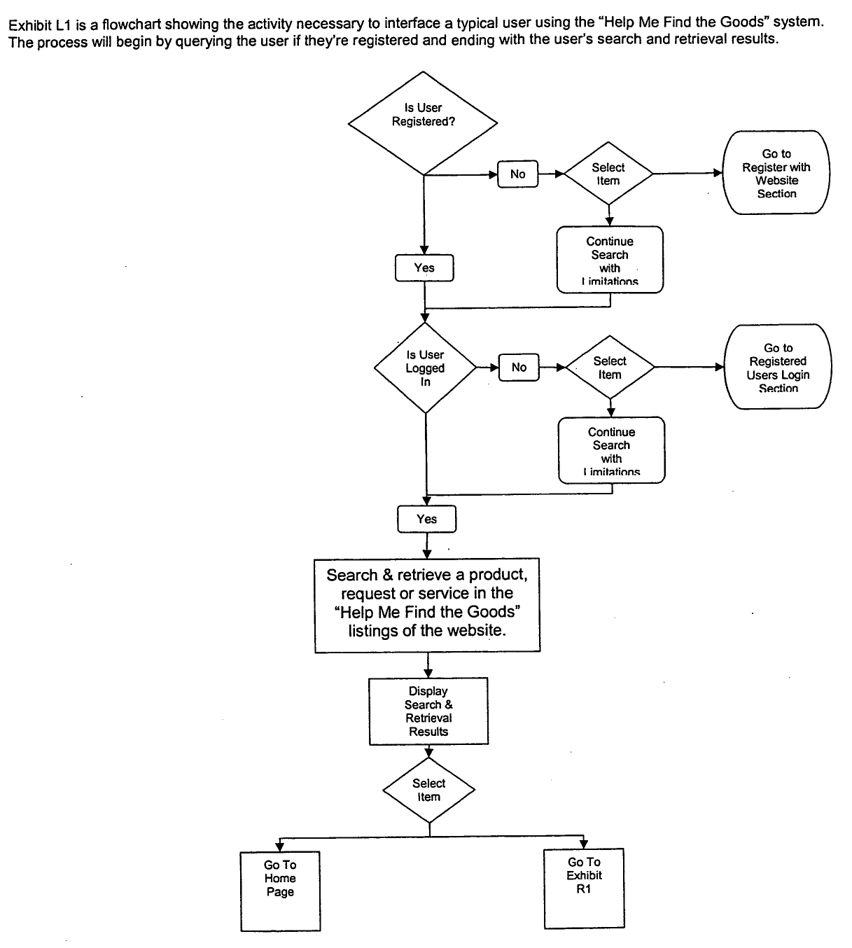

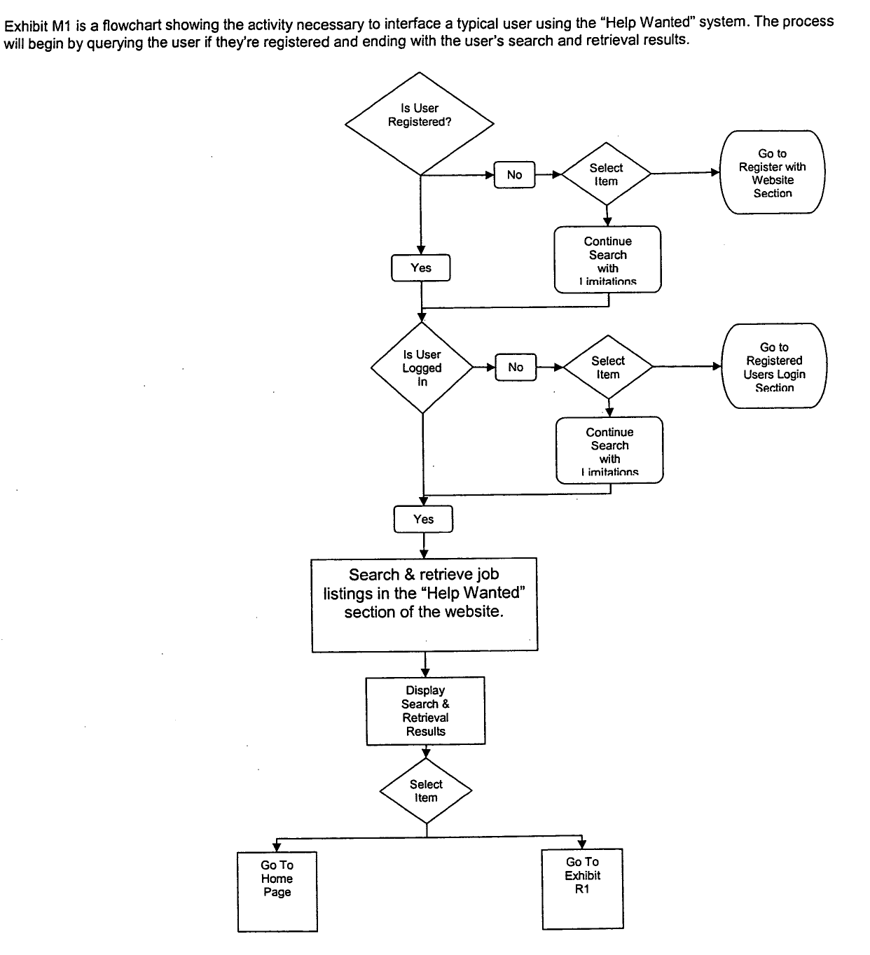

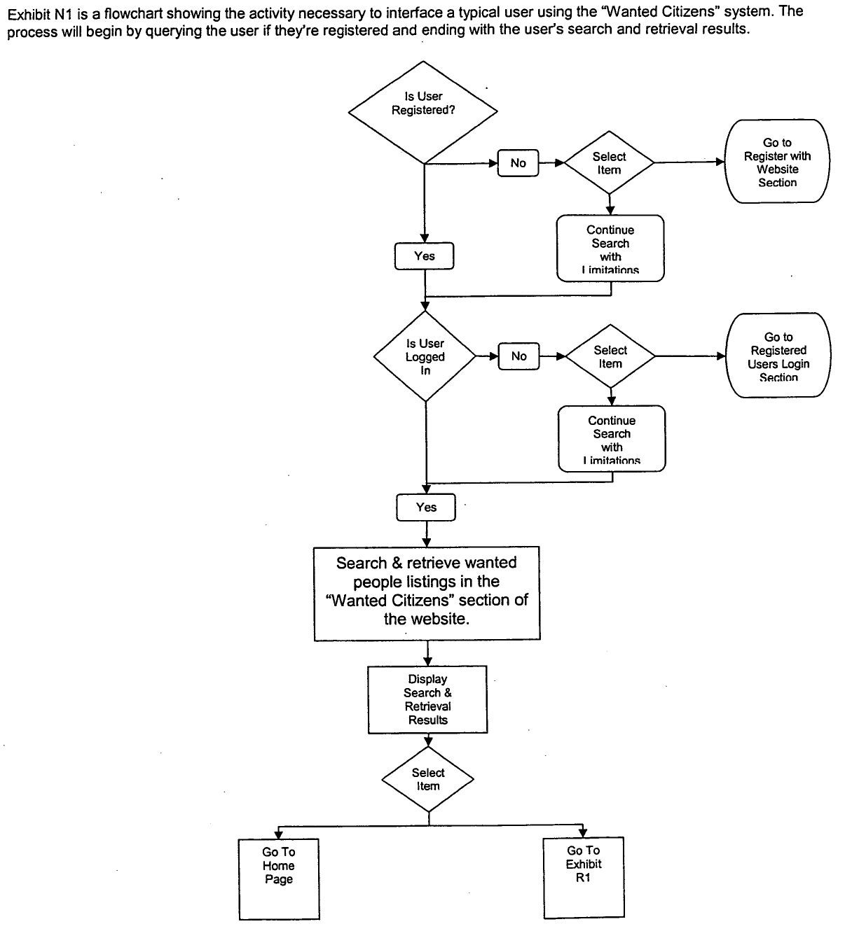

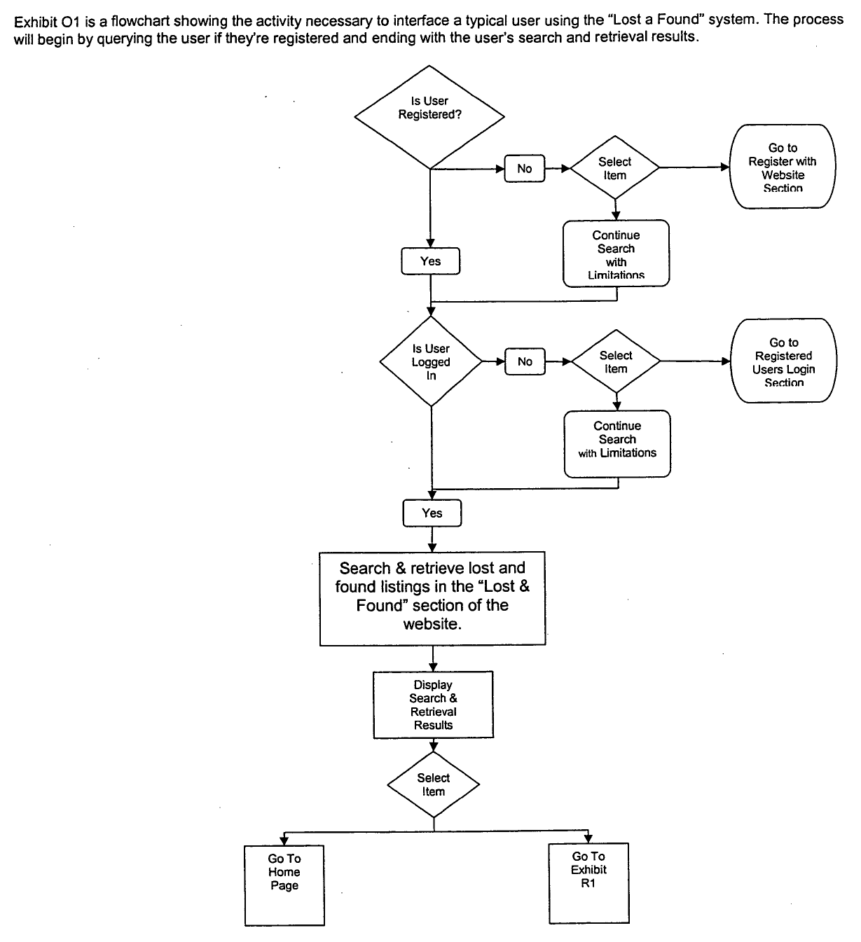

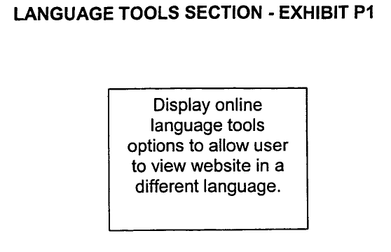

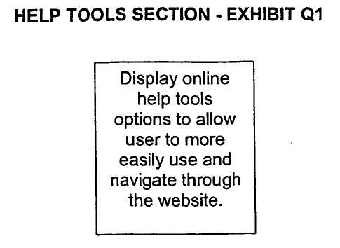

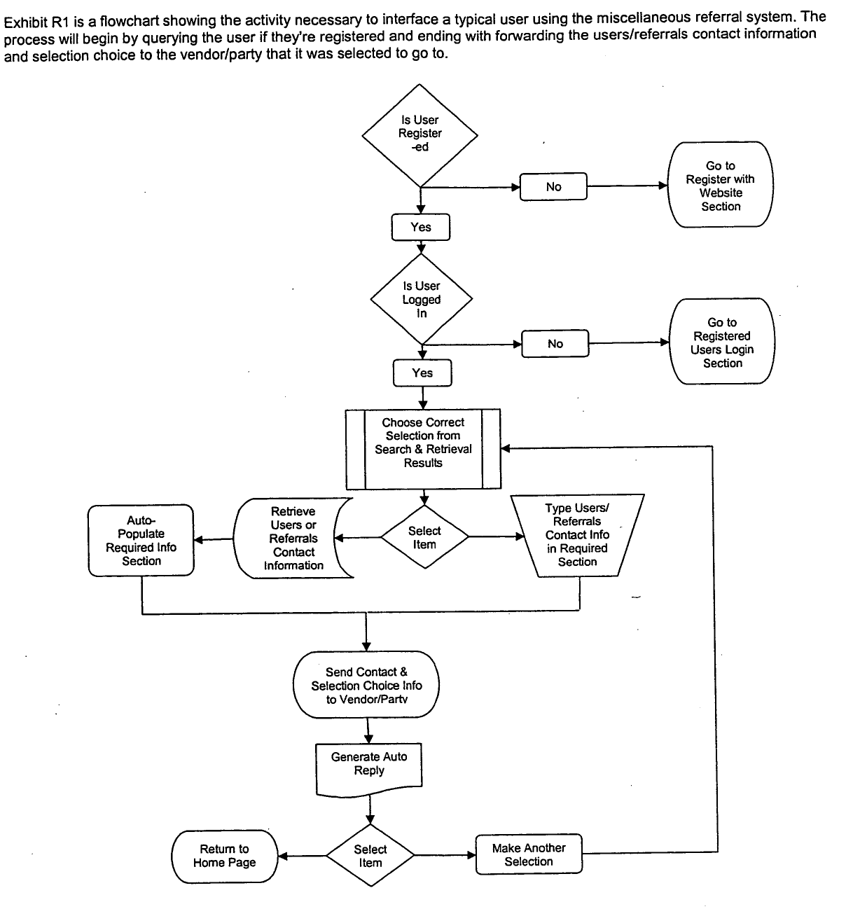

Homepage—FIG. 1A, 1B and 1C, as found in the drawings, illustrate the main and general options a user has to choose from when entering the homepage of the website. The options the users have available to them are designed to benefit both frequent and first time users of the website. This main page allows the user to directly proceed to any sub page of the website. If the user is not familiar with all of the aspects of the site their best option might be to choose the “New to Website” page. By entering this selection, on online audio and video tutorial will be displayed describing all the valuable and unique features and sections of the website. The “Help Tools” selection can also be accessed from the homepage. This section will aid those who are having problems operating or navigating through any part of the website.

Registered Users—If the user is a past or frequent user of the website, then the webpage featured as Exhibit A1, known as the “Registered Users Login Section”, will be a regularly visited page. This page will be one of the most heavily accessed pages since this is where previously registered users login. In this area they are able to access their own personal and business records as well as past transactions only accessible to them. When properly accessing this section users will have more detailed and advanced access to certain pages and tools featured through out the site. By accessing this section, it will also typically shorten the amount of time it takes users to complete certain transactions. This is because the website can retrieve a pre-registered user's personal or business information, their previous records of past referrals, or previous business selections. This means much of their previous information will be able to simply be downloaded instead of having to manually reenter required information again in order to complete a referral transaction.

If a user has previously registered with the website, the user will also have access to the “Account Balance and Payment History” page as featured in Exhibit A1.1. This section is able to show the user monetary account balances as well as their previous payment history. In the “Current and Prior Account Activity” section as featured in Exhibit A1.2 the user has the capability to actually look up all current and prior account activity which includes the dates and names of the persons or businesses associated with those transactions. If the user's business or personal information was to ever change the “Business or Personal Information Page” would be accessed. This page shows the user their current information and allows them to make any changes as necessary. This page is featured as Exhibit A1.3 in the drawings.

Payment System—In Exhibit E1, also known as “Register or Update Info with Payment System” area, illustrates the process to either register with this online payment system or just to update the current information. This convenient method of payment is the preferred method of payment for users utilizing the website. Effective payment method system for parties purchasing products or service “on-line” or from websites have been heretofore developed. The payment system used to facilitate the payments contemplated under the system presented herein will be similar to such known systems. For instance, PayPal, a well known internet business transaction company, uses a payment system that would be a payment system of the type that could be used in this invention. A preferred payment system would comprise at least registration methods, information collection and storage, security features, technology, logic, instructions such as would be found in payment systems now used in internet transactions. This electronic payment system would be the preferred payment option for businesses paying advertising fees to the website or payments being made to those who have earned a monetary reward or finder's fee.

Exhibit F1, also listed as “Make This Site Your Homepage” section, represents an electronic predefined process that automatically makes the homepage of this website, a person's homepage on their computer when they open up Internet Explorer.

Help Me Find the Goods—Exhibit L1, also referred to as the “Help Me Find the Goods” section, shows the process a user must follow in order to view the items, requests, or services listed in this section. This area, unlike other sections, promotes people coming to the buyers. The buyer in this case is responsible for paying for the ad on the website. In this instance a buyer would offer a finder's fee or reward to any party who finds them a unique item, product or service that they were looking for at their requested specification and/or price.

This could include hard to find items at an affordable price for the buyer. Examples include: vintage cars, rare coins or stamps, collectibles, the perfect mate, special event tickets, meeting a movie star, rare paintings, unusual animals, etc. In this section of the website however, the buyer would determine the amount of the finder's fee, what the finder's fee is, the time frame in which it will be paid and if more than one person is eligible to receive a finder's fee. As mentioned previously, these parameters must fall within the website's guidelines.

The “Help Me Find the Goods” portion of the website will be developed to provide an effective search and retrieval system for any party using the inventors' system and method.

Help Wanted—Exhibit M1, also listed as the “Help Wanted” section, shows the process a user must follow in order to search and retrieve worldwide job listings. This segment would be specifically designed and set up to help an employer (seller) find a potential employee. The employer in this case would typically be responsible for paying for the ad on the website. Under this scenario a potential employer or employment agency will pay a finder's fee or reward to any party(s) who refers to them a qualified applicant, according to the employer's prerequisites. Under this segment the employer would determine the amount of the reward, what the reward is, time frame in which it will be paid and if more than one person is eligible to receive a reward. As mentioned previously, these parameters must fall within the website's guidelines.

Wanted Citizens—Exhibit N1, also known as the “Wanted Citizens” section, shows the process a user must follow in order to search and retrieve wanted people. This section is also unlike most others because it posts worldwide rewards or finder's fees for wanted people. This portion would typically contain runaways, suspects or criminals along with their picture and or physical description. These listings would also describe the events and dates that led up to the person's disappearance or the reason that the person is being sought. In this scenario a party would offer a finder's fee or reward to any party who finds or who gives valuable information leading to the capture of an individual(s) or the finding of the missing person. The individual(s) responsible for placing the ad would typically determine the amount of the reward, what the reward is, the time frame in which it will be paid and if more than one person is eligible to receive a reward. As mentioned previously, these parameters must fall within the website's guidelines.

Lost and Found Section—Exhibit O1, also known as the “Lost and Found” section, shows the process a user must follow in order to search and retrieve missing items, animals or people. In this area, a party would offer a reward for anything or anyone that is lost or missing. This may include items, animals, or people. In addition, their posted reward advertisement would include the dates, places, pictures and descriptions surrounding the missing items, animals or person's disappearance. This section may also be utilized just to help reestablish lost connections with a former loved one or acquaintance. The individual(s) responsible for placing the ad would typically determine the amount of the reward, what the reward is, the time frame in which it will be paid and if more than one person is eligible to receive a reward. Furthermore, any potential reward recipients will still be subject to meeting certain parameters established by the reward giver in order to be eligible. As mentioned previously, these parameters must fall within the website's guidelines.

This same section would also feature an area listing all found items. This area would include the found item's physical description and/or picture. The reward amount being paid to the finder of a lost item would be paid out by the rightful owner of the lost item. In this scenario, a minimum monetary reward amount would be required to at least equal or be greater than the finder's cost of the website advertisement.

Miscellaneous Referrals—Exhibit R1, also known as the “Miscellaneous Referral Section”, shows how a user will typically locate a vendor or advertiser only from the Help Me Find the Goods, Help Wanted, Wanted Citizens, or Lost and Found sections. After selecting the appropriate vendor or advertiser, the diagram shows the process necessary in order to refer your self or an acquaintance to the merchant or person selected. This outline also illustrates how the contact information is forwarded to the advertiser and that an auto reply is automatically generated back to the referring party.

Recap—The overall result of offering a referral and reward based website of this size is that it serves as a dynamic global advertising medium for anyone either wanting to sell or obtain any product, service or difficult to acquire item. It also aids individuals who are seeking employment, wanted people, missing loved ones, things of personal or monetary value that have been lost, or hard to fill requests or events. Some of the sample sellers wishing to advertise in this website may include: Car dealerships, lawyers, apartment complexes, real estate companies, boat dealers, R.V. dealers, cell phone companies, banks, wedding planners, employment agencies, advertising firms and agencies (television, radio, newspaper), dentists, doctors, cosmetic surgeons, insurance companies, retail stores, plumbers, roofers, painters, landscapers, carpet cleaners, hotels, airlines, restaurants, hair salons, cruise lines, etc. The advertising possibilities are as numerous as the number of businesses listed in every telephone book, in every city, in every state through out the country and around the world. The method and system presented herein is an internet-based method for generating sales leads for a business and rewarding a party for referring a second party to the business. In one embodiment there is provided a website for the business to promote products or services, there is a module of the system providing a transaction system data base, and another module for authorizing allocation of a finder's fee to a party that refers a second party to the business when the second party contracts, as if by a sale or other transaction, with the business for a transfer of goods or services. Various modules can be added to this capability for instance a feedback system can be provided which comprising a rating system to rate the business, the products or services of the business as presented on the business's website and said second party.

Furthermore, the inventors contemplate providing a pricing system that lists the costs of products or services featured on the business website. Other modules that may be incorporated into the system and method include the provision of a Help Me Find the Goods capability that facilitates a party in locating a product or service at the party's directed specification and/or cost; a Help Wanted capability designed to help an employer find a potential employee; a Wanted Citizens capability to help find Wanted Citizens; and a Lost and Found capability designed to help retrieve missing items, animals or people and find the rightful owners or location of found items, animals or people. In broad terms the computer based business method set forth above comprises, among the other aspects of the invention set forth above, providing a system for a business or an individual to allocate a reward or finder's fee to any party that finds them a unique item, product or service at their requested specification and/or price, an employee for their business, a wanted individual, a lost item, animal or person or anything that was found.

While the invention is described herein in terms of preferred embodiments and generally associated methods, the inventor contemplates that alterations and permutations of the preferred embodiments and methods will become apparent to those skilled in the art upon a reading of the specification and a study of the figures. Accordingly, neither the above description of preferred exemplary embodiments nor the abstract defines or constrains the invention. Rather, the issued claims variously define the invention. Each variation of the invention is limited only by the recited limitations of its respective claim, and equivalents thereof, without limitation by other terms not present in the claims.

1. An internet-based method for generating sales leads for a business and rewarding a party for referring a second party to said business comprising:
(a) providing a website for said business to promote products or services,
(b) providing a transaction system data base,
(c) authorizing allocation of a finder's fee to a party that refers a second party to said business upon said second party contracting with said business for a transfer of goods or services.

2. The method of claim 1 further comprising providing a feedback system comprising a rating system to rate said business, said products or services presented on the business's website and said second party.

3. The method of claim 1 further comprising providing a pricing system that lists the costs of said products or services featured on said website.

4. The method of claim 1 further comprising providing a Help Me Find the Goods capability that facilitates a party in locating a product or service at said party's directed specification and/or cost.

5. The method of claim 1 further comprising providing a Help Wanted capability designed to help an employer find a potential employee.

6. The method of claim 1 further comprising providing a Wanted Citizens capability to help find Wanted Citizens.

7. The method of claim 1 further comprising providing a Lost and Found capability designed to help retrieve missing items, animals or people and find the rightful owners or location of found items, animals or people.

8. The method of claim 1 further comprising providing a system for said business or an individual to allocate a reward or finder's fee to any party that finds them a unique item, product or service at their requested specification and/or price, an employee for their business, a wanted individual, a lost item, animal or person or anything that was found.
